(19) United States
(12) Patent Application Publication
(10) Pub. No.: US 2026/0074580 A1
(43) Pub. Date: Mar. 12, 2026

(54) ROTOR SUPPORT METHOD FOR GENERATOR OF HYBRID APPLICATION

(71) Applicant: Schaeffler Technologies AG & Co. KG, Herzogenaurach (DE)

(72) Inventor: Matthew Payne, Glenmont, OH (US)

(73) Assignee: Schaeffler Technologies AG & Co. KG, Herzogenaurach (DE)

(21) Appl. No.: 18/828,195

(22) Filed: Sep. 9, 2024

(51) Int. Cl. H02K 5/16; H02K 5/10; H02K 7/00; H02K 7/18

(52) U.S. Cl. CPC H02K 5/16; H02K 5/10; H02K 7/006; H02K 7/1807

(57) ABSTRACT

A generator for a hybrid vehicle includes a housing including an end cover having an axially extending center support, a stator supported in the housing, a rotor assembly supported for rotation in the housing relative to the stator, and a center shaft coaxial with the rotor assembly. The center shaft is supported for rotation at a first axial position by the center support of the end cover, the center shaft extends axially from the center support and supports the rotor assembly at a second axial position, and the rotor assembly is supported at the first axial side of the generator by a support plate extending radially between a carrier of the rotor assembly and the center support of the housing.

### TECHNICAL FIELD

The present disclosure relates generally to hybrid vehicles, and more specifically to a drivetrain for a hybrid vehicle.

### BACKGROUND

In general, drivetrains for hybrid vehicles are known. These drivetrains typically include an internal combustion engine and an electric motor. Depending on the configuration of the hybrid drivetrain, a battery and/or a generator may be provided.

In a series hybrid drivetrain, an internal combustion engine (ICE) is mechanically coupled to a generator which supplies electrical power to at least one electric motor for driving wheel of a vehicle and/or a battery for storing power. The generator in a series hybrid drivetrain by nature connects directly to the ICE but has no mechanical output to the rest of the powertrain. To cost optimize the torque connection between the ICE crank shaft and generator rotor, there is typically no mis-alignment compensation mechanism such as a crank mounted damper. Therefore, a simple two bearing support architecture inside the generator to hold the rotor before it its mated to crank shaft is not used. Instead, the rotor is supported inside the generator by a single bearing, and the ICE rear main bearing becomes the second bearing support for the rotor once connected. Prior to making this connection, the rotor is not supported resulting in air gap contact and potential damage of the front dynamic lip seal.

To address this issue, conventional solutions typically hold the rotor positioned during assembly via tooling or integrated centering features. One option utilizes mating conical surfaces within the generator and an externally applied load to keep the conical surfaces engaged during assembly. The externally applied load typically must be applied to the rotor through a rear surface of the generator opposite the ICE, either by tooling or bolts, that apply load to maintain the conical surfaces in an engaged configuration until connection with the crankshaft of the ICE.

### SUMMARY

In applications where access to the rear of the generator to apply load is not available, damage to seals can occur prior to coupling of the generator to the crankshaft of the ICE as the rotor is not fully supported. Embodiments according to this disclosure provide an arrangement for supporting the rotor prior to crankshaft coupling.

In accordance with one aspect of the present disclosure, a generator for a hybrid vehicle comprises a housing including an end cover having an axially extending center support, a stator supported in the housing, a rotor assembly supported for rotation in the housing relative to the stator, and a center shaft coaxial with the rotor assembly. The center shaft is supported for rotation at a first axial position by the center support of the end cover, the center shaft extends axially from the center support and supports the rotor assembly at a second axial position, and the rotor assembly is supported at the first axial side of the generator by a support plate extending radially between a carrier of the rotor assembly and the center support of the housing.

The center shaft can be supported for rotation by a first bearing in a bore of the center support. The support plate can be supported for rotation by a second bearing on an outer diameter of the center support. The first bearing and the second bearing can be axially offset along the center support. At least one of the first bearing or second bearing can comprise a bushing. The center shaft can be coupled to a hub, and the hub can be coupled to the carrier of the rotor, whereby the center shaft provides cantilevered support to the hub. The center shaft can be press-fit into the hub. A seal can extend between the housing and the hub. A drive plate can be configured to be coupled to the hub, wherein the drive plate can be configured to receive torque from an engine crankshaft to rotate the rotor assembly. The center shaft can include an axial passageway for distributing fluid to at least one of the first bearing, the second bearing or the rotor assembly.

In accordance with another aspect, a drivetrain for an electric or hybrid vehicle includes and engine and a generator as set forth herein.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of an exemplary generator in accordance with the present disclosure.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

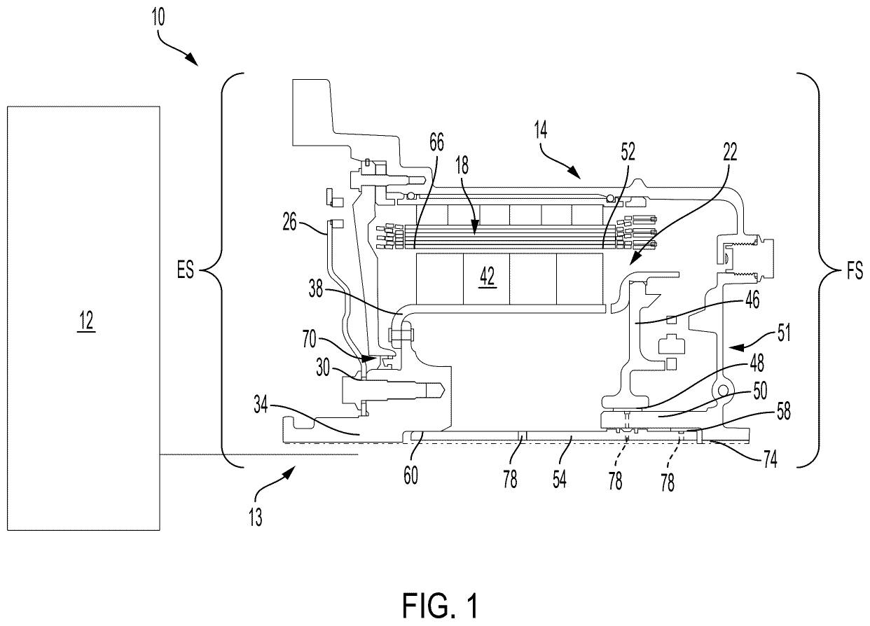

Referring to FIG. 1, an exemplary generator in accordance with the present disclosure is illustrated and identified generally by reference numeral 10. FIG. 1 is a cross-sectional view taken through a central rotational axis of the generator 10 showing one half of the generator 10. It will be appreciated that the generator 10 is generally symmetrical about the axis of rotation. As used herein, the generator 10 has an engine side ES, which refers to a side of the generator 10 configured to be attached to or face an engine 12 (e.g., internal combustion engine or ICE, shown schematically in FIG. 1) when installed in a vehicle, and a firewall side FS, which refers to a side of the generator 10 opposite the engine side ES and, in some installations towards a firewall of a vehicle.

The generator 10 includes a housing 14 supporting a stator 18 and a rotor assembly 22. A drive plate 26 is configured to be coupled to a crankshaft 13 of an ICE (crankshaft 13 and connection to drive plate 26 shown schematically in FIG. 1). Torque is transmitted through the drive plate 26 and passes through a bolted (or other) connection 30 into a crank hub 34 which is riveted or otherwise coupled to a rotor carrier 38 supporting a rotor 42. The rotor carrier 38 and rotor 42 are supported on the firewall side FS via a bushing support plate 46 and a bushing 48 which runs on a hub interface of a center support 50 of an end portion 51 the housing 14 of the generator 10. Bushing support plate 46 and bushing 48 support the rotor carrier 38 to maintain a firewall side FS air gap 52 between the rotor 42 and the stator 18.

A center shaft 54, supported at a first end on a bushing 58 received in the center support 50 of the end portion 51, and is pressed into the crank hub 34 inside diameter at connection 60 at a second end. Bushing 48 and bushing 58 cooperate via to support the center shaft 54 to provide cantilevered support to the crank hub 34 to maintain an engine side air gap 66 between the rotor 42 and the stator 18 thereby protecting shaft seal 70 from radial displacement prior to connection of the generator 10 to the crankshaft of the ICE. The center shaft 54 is configured to have a stiffness adequate to maintain the engine side air gap 66 but flexible enough to avoid over constraining the system considering crankshaft dynamics.

The firewall side FS of the center shaft 54 includes a central passageway 74 configured to receive cooled oil from the housing 14. A plurality of radial holes 78 distribute the oil to bushing 48, bushing 58 and/or generally to an radially inner portion of the rotor assembly 22 as centrifugal rotor spray for cooling and lubrication of the components of the generator 10.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### Log of Reference Numerals

10 generator
12 engine
13 crankshaft
14 housing
18 stator
22 rotor assembly
26 drive plate
30 connection
34 crank hub
38 rotor carrier
42 rotor
46 bushing support plate
48 bushing
50 center support
51 end portion
52 air gap
54 center shaft
58 bushing
60 connection
66 air gap
70 seal
74 central passageway
78 radial hole
ES engine side
FS firewall side

What is claimed is:

1. A generator for a hybrid vehicle comprising:
a housing including an end cover having an axially extending center support;
a stator supported in the housing;
a rotor assembly supported for rotation in the housing relative to the stator; and
a center shaft coaxial with the rotor assembly;
wherein the center shaft is supported for rotation at a first axial position by the center support of the end cover;
wherein the center shaft extends axially from the center support and supports the rotor assembly at a second axial position; and
wherein the rotor assembly is supported at the first axial side of the generator by a support plate extending radially between a carrier of the rotor assembly and the center support of the housing.

2. The generator according to claim 1, wherein the center shaft is supported for rotation by a first bearing in a bore of the center support.

3. The generator according to claim 2, wherein the support plate is supported for rotation by a second bearing on an outer diameter of the center support.

4. The generator according to claim 3, wherein the first bearing and the second bearing are axially offset along the center support.

5. The generator according to claim 4, wherein at least one of the first bearing or second bearing comprises a bushing.

6. The generator according to claim 4, wherein the center shaft is coupled to a hub, and wherein the hub is coupled to the carrier of the rotor, whereby the center shaft provides cantilevered support to the hub.

7. The generator according to claim 6, wherein the center shaft is press-fit into the hub.

8. The generator according to claim 6, further comprising a seal extending between the housing and the hub.

9. The generator according to claim 6, further comprising a drive plate configured to be coupled to the hub, wherein the drive plate is configured to receive torque from an engine crankshaft to rotate the rotor assembly.

10. The generator according to claim 1, wherein the center shaft includes an axial passageway for distributing fluid to at least one of the first bearing, the second bearing or the rotor assembly.

11. A drivetrain for an electric or hybrid vehicle comprising:
an engine including a crankshaft; and
a generator driven by the crankshaft of the engine;
wherein the generator includes:
a housing including an end cover having an axially extending center support;
a stator supported in the housing;
a rotor assembly supported for rotation in the housing relative to the stator; and
a center shaft coaxial with the rotor assembly;
wherein the center shaft is supported for rotation at a first axial position by the center support of the end cover;
wherein the center shaft extends axially from the center support and supports the rotor assembly at a second axial position; and
wherein the rotor assembly is supported at the first axial side of the generator by a support plate extending radially between a carrier of the rotor assembly and the center support of the housing.

12. The drivetrain according to claim 11, wherein the center shaft is supported for rotation by a first bearing in a bore of the center support.

13. The drivetrain according to claim 12, wherein the support plate is supported for rotation by a second bearing on an outer diameter of the center support.

14. The drivetrain according to claim 13, wherein the first bearing and the second bearing are axially offset along the center support.

15. The drivetrain according to claim 14, wherein at least one of the first bearing or second bearing comprises a bushing.

16. The drivetrain according to claim 14, wherein the center shaft is coupled to a hub, and wherein the hub is coupled to the carrier of the rotor, whereby the center shaft provides cantilevered support to the hub.

17. The drivetrain according to claim 16, wherein the center shaft is press-fit into the hub.

18. The drivetrain according to claim 16, further comprising a seal extending between the housing and the hub.

19. The drivetrain according to claim 16, further comprising a drive plate configured to be coupled to the hub, wherein the drive plate is configured to receive torque from an engine crankshaft to rotate the rotor assembly.

20. The drivetrain according to claim 11, wherein the center shaft includes an axial passageway for distributing fluid to at least one of the first bearing, the second bearing or the rotor assembly.
